(19) United States
(12) Patent Application Publication
(10) Pub. No.: US 2012/0274245 A1
(43) Pub. Date: Nov. 1, 2012

(54) Power Tool and Battery Pack

(75) Inventors: Nobuhiro Takano, Hitachinaka-shi (JP); Kazuhiko Funabashi, Hitachinaka-shi (JP); Yukihiro Shima, Hitachinaka-shi (JP); Eiji Nakayama, Hitachinaka-shi (JP)

(73) Assignee: HITACHI KOKI CO. LTD., Tokyo (JP)

(21) Appl. No.: 13/496,810

(22) PCT Filed: Jan. 21, 2011
(86) PCT No.: PCT/JP2011/051682

§ 371 Date: May 25, 2012

(30) Foreign Application Priority Data
Jan. 22, 2010 (JP) 2010-012593

(51) Int. Cl. H02P 1/02

(52) U.S. Cl. 318/139

(57) ABSTRACT

A power tool is connectable to a battery pack including a secondary battery. The power tool includes a motor and a prohibiting unit. The motor is driven with an electrical power supplied from the secondary battery. The prohibiting unit prohibits the supply of the electrical power to the motor based on a drop amount of a voltage of the secondary battery.

### TECHNICAL FIELD

The present invention relates to a power tool and a battery pack capable of preventing an overcurrent from flowing in a secondary battery.

### BACKGROUND ART

Conventionally, a lithium-ion secondary battery is widely used as a secondary battery for driving a cordless power tool (hereinafter, to be referred to as “power tool”) that requires a large amount of power. However, a battery life of the lithium-ion secondary battery becomes excessively short if an overcurrent flows in the secondary battery. To this effect, a battery pack that detects the occurrence of the overcurrent based on a current flowing in a secondary battery of a power tool and prohibits a power supply to the power tool when the occurrence of the overcurrent is detected, is proposed (See Laid-open Japanese Patent Application Publication No. 2006-281404, for example).

### DISCLOSURE OF INVENTION

### Technical Problem

It is an object of the present invention to provide a power tool and a battery pack capable of preventing an overcurrent from flowing in a secondary battery without detecting a current.

### Technical Solution

In order to achieve the above and other objects, the present invention provides a power tool connectable to a battery pack including a secondary battery. The power tool includes a motor driven with an electrical power supplied from the secondary battery; and a prohibiting unit that prohibits the supply of the electrical power to the motor based on a drop amount of a voltage of the secondary battery.

With this configuration, an overcurrent can be prevented from flowing in the secondary battery without detecting a current.

Preferably, the prohibiting unit prohibits the supply of the electrical power to the motor when the drop amount exceeds a first threshold.

Preferably, the first threshold depends on at least one of a temperature of the secondary battery and a capacity of the secondary battery.

With this configuration, an overcurrent can be prevented from flowing in the secondary battery more appropriately.

Preferably, the power tool further includes a trigger switch that is manually closed to supply the electrical power to the motor. Once prohibiting the supply of the electrical power to the motor, the prohibiting unit continues to prohibit the supply of the electrical power to the motor until the trigger switch is opened.

With this configuration, the supply of the electrical power to the motor can be prevented from being repeatedly permitted and prohibited in a short period of time.

Preferably, the power tool further includes a trigger switch that is manually closed to supply the electrical power to the motor. The prohibiting unit detects the drop amount every predetermined period since the trigger switch has been closed, the predetermined period being set to a value such that the prohibiting unit fails to detect the drop amount occurring due to a starting current.

With this configuration, the supply of the electrical power to the motor can be prevented from being prohibited at the starting time of the motor.

Preferably, the prohibiting unit prohibits the supply of the electrical power to the motor by shutting off a switching unit disposed on a current path between the secondary battery and the motor.

With this configuration, the supply of the electrical power to the motor can be reliably shut down.

Preferably, the secondary battery is a lithium-ion secondary battery.

With this configuration, the overcurrent prevention is more efficient for the lithium-ion secondary battery.

Preferably, the prohibiting unit prohibits the supply of the electrical power to the motor, at least one of when the drop amount exceeds the first threshold and when a capacity of the secondary battery falls below a second threshold for an overdischarge.

With this configuration, the decrease in the battery life of the secondary battery can be suppressed more effectively.

Another aspect of the present invention provides a battery pack connectable to a power tool including a motor. The battery pack includes a secondary battery that supplies an electrical power to the motor to drive the motor; and a prohibiting unit that prohibits the supply of the electrical power to the motor based on a drop amount of a voltage of the secondary battery.

With this configuration, an overcurrent can be prevented from flowing in the secondary battery without detecting a current.

Preferably, the prohibiting unit prohibits the supply of the electrical power to the motor when the drop amount exceeds a first threshold.

Preferably, the first threshold depends on at least one of a temperature of the secondary battery and a capacity of the secondary battery.

With this configuration, an overcurrent can be prevented from flowing in the secondary battery more appropriately.

Preferably, the power tool further includes a trigger switch that is manually closed to supply the electrical power to the motor. Once prohibiting the supply of the electrical power to the motor, the prohibiting unit continues to prohibit the supply of the electrical power to the motor until the trigger switch is opened.

With this configuration, the supply of the electrical power to the motor can be prevented from being repeatedly permitted and prohibited in a short period of time.

Preferably, the power tool further includes a trigger switch that is manually closed to supply the electrical power to the motor. The prohibiting unit detects the drop amount every predetermined period since the trigger switch has been closed, the predetermined period being set to a value such that the prohibiting unit fails to detect the drop amount occurring due to a starting current.

With this configuration, the supply of the electrical power to the motor can be prevented from being prohibited at the starting time of the motor.

Preferably, the prohibiting unit prohibits the supply of the electrical power to the motor by shutting off a switching unit disposed on a current path between the secondary battery and the motor.

With this configuration, the supply of the electrical power to the motor can be reliably shut down.

Preferably, the secondary battery is a lithium-ion secondary battery.

With this configuration, the overcurrent prevention is more efficient for the lithium-ion secondary battery.

Preferably, the prohibiting unit prohibits the supply of the electrical power to the motor, at least one of when the drop amount exceeds the first threshold and when a capacity of the secondary battery falls below a second threshold for an overdischarge.

With this configuration, a decrease in a life of the secondary battery can be suppressed more effectively.

### Advantageous Effects

According to the power tool and the battery pack of the present invention, an overcurrent can be prevented from flowing in a secondary battery without detecting a current, thereby suppressing a decrease in a life of the secondary battery.

### BRIEF DESCRIPTION OF DRAWINGS

In the drawings:

FIG. 1 is a general overview of a power tool and a battery pack according to a first embodiment of the present invention;

FIG. 2 is a schematic circuit diagram of the power tool and the battery pack according to the first embodiment;

FIG. 3 is a flowchart explaining a power supply prohibition determination according to the first embodiment;

FIG. 4 is a view explaining changes in a voltage and a current in each battery cell when the power supply prohibition determination according to the first embodiment is performed;

FIG. 5 is a view showing an example of a table stored in a power supply prohibition unit according to the first embodiment;

FIG. 6(a) is a time chart showing timings at which a trigger switch is closed and open when a trigger switch is closed in a state where the battery pack is connected to the power tool;

FIG. 6(b) is a time chart showing changes in voltages VA, VB and VC at junctions A, B and C of FIG. 2, respectively, in correspondence with FIG. 6(a);

FIG. 6(c) is a time chart showing a current flowing in each battery cell in correspondence with FIG. 6(a);

FIG. 7(a) is a time chart showing timings at which the trigger switch is closed and opened;

FIG. 7(b) is a time chart showing changes in the voltages VA and VB at the junctions A and B of FIG. 2 when the battery pack is connected to the power tool in a state where the trigger switch is closed, respectively, in correspondence with FIG. 7(a);

FIG. 8 is a flowchart explaining a power supply prohibition determination according to a second embodiment of the present invention;

FIG. 9 is a view explaining changes in a voltage and a current in each battery cell when the power supply prohibition determination according to the second embodiment is performed;

FIG. 10 is a view explaining changes in voltages and currents at the time of a power supply prohibition determination according to a modification to the first embodiment; and

FIG. 11 is a flowchart explaining the power supply prohibition determination according to the modification to the first embodiment.

### EXPLANATION OF REFERENCE

1 power tool
2 motor
31 trigger switch
41 main current switch circuit
410 FET
42 main current switch-off maintaining circuit
5 battery pack
51 battery
533 power supply prohibiting section

### BEST MODE FOR CARRYING OUT THE INVENTION

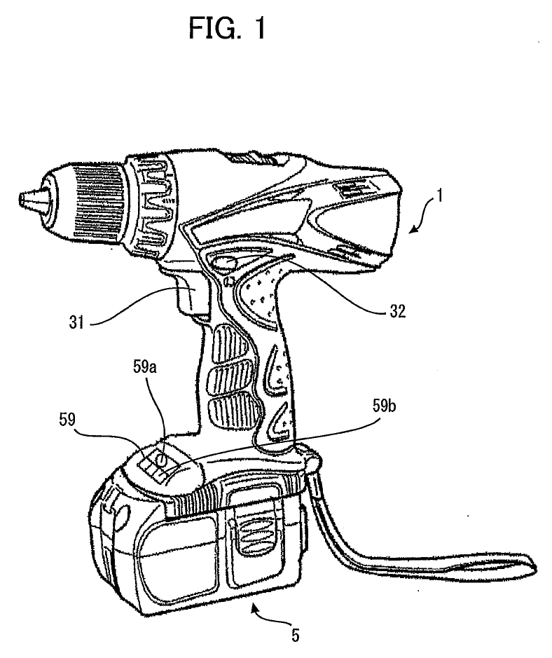

A power tool 1 and a battery pack 5 according to a first embodiment of the present invention will be described with reference to FIGS. 1 through 7.

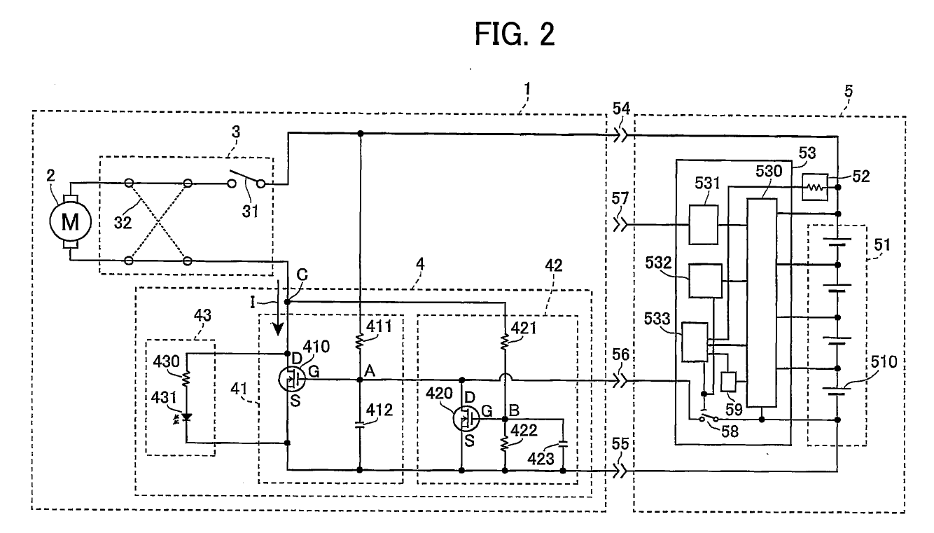

FIG. 1 is a general overview of a power tool 1 and a battery pack 5 according to the first embodiment. FIG. 2 is a schematic circuit diagram of the power tool 1 and the battery pack 5 according to the first embodiment. As shown in FIG. 2, the power tool 1 and the battery pack 5 are detachably connectable to each other via a positive terminal 54, a negative terminal 55 and a prohibition signal output terminal 56. Note that when charged, the battery pack 5 is connected to a charger (not shown) via the positive terminal 54, the negative terminal 55 and an overcharge output terminal 57.

First, an electrical configuration of the power tool 1 will be described. The power tool 1 (a driver drill, for example) includes a motor 2, a switch unit 3 and a controller 4, as shown in FIG. 2.

The motor 2 is connected between the positive terminal 54 and the negative terminal 55 via the switch unit 3 and the controller 4. The switch unit 3 includes a trigger switch 31 and a forward-reverse switch 32. The trigger switch 31 is connected between the motor 2 and the positive terminal 54. The trigger switch 31 is opened/closed in accordance with user's operations. The forward-reverse switch 32 serves to change the rotating direction of the motor 2.

When the battery pack 5 (for example, fully charged battery pack 5) is connected to the power tool 1, a voltage is applied between the positive terminal 54 and the negative terminal 55. When the trigger switch 31 is closed, a closed circuit is formed between the battery pack 5 and the motor 2 via the controller 4, thereby the voltage is applied to the motor 2. Thus, the motor 2 is driven to operate an end bit (not shown) connected to the motor 2.

The controller 4 functions to shut off the closed circuit to stop driving the motor 2 when receiving a signal indicative of prohibition of the power supply from the prohibition signal output terminal 56 of the battery pack 5. A detailed configuration of the controller 4 will be described later.

Next, a configuration of the battery pack 5 will be described. As shown in FIG. 2, the battery pack 5 includes a battery 51, a thermistor 52, a battery protection IC 53 and a residual capacity detection unit 59. The battery protection IC 53 may be a microcomputer.

The battery 51 is configured of four battery cells 510 (secondary batteries) each connected in series between the positive terminal 54 and the negative terminal 55. In the present embodiment, each battery cell 510 is a lithium-ion secondary battery having a rated voltage of 3.6V. Since the battery 51 has four battery cells 510 of 3.6V connected in series, the battery 51 has a battery voltage of 14.4V. The thermistor 52 is disposed adjacent to the battery 51 to output a signal indicative of a temperature of the battery 51 (battery temperature T). As a variation, two batteries 51 connected in parallel may be connected between the positive terminal 54 and the negative terminal 55 in order to obtain a larger capacity. Alternatively, as the battery 51, more than or less than four battery cells 510 may be connected.

The battery protection IC 53 includes a voltage detecting section 530, an overcharge detecting section 531, an overdischarge detecting section 532, a power supply prohibiting section 533 and a switch 58. In case that the battery protection IC 53 is a microcomputer, a CPU of the microcomputer functions as the voltage detecting section 530, the overcharge detecting section 531, the overdischarge detecting section 532 and the power supply prohibiting section 533.

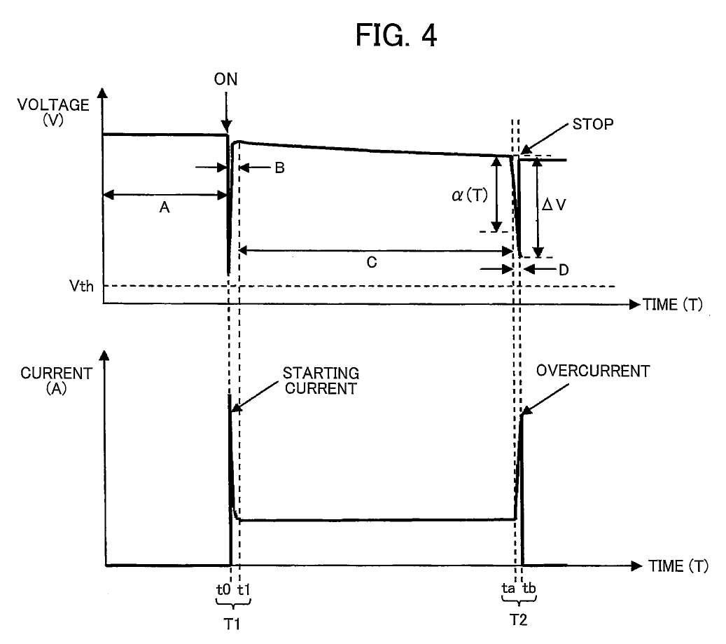

The voltage detecting section 530 detects respective voltages of the battery cells 510 and outputs the detected voltages to the overcharge detecting section 531, the overdischarge detecting section 532 and the power supply prohibiting section 533. If any one of the voltages of the battery cells 510 exceeds a predetermined value (an overcharge threshold value) during the charge of the battery cells 510, the overcharge detecting section 531 determines that overvoltage has occurred, and outputs a signal indicative of termination of charging to the charger via the overcharge output terminal 57. If any one of the voltages of battery cells 510 falls below a prescribed value (an overdischarge threshold Vth in FIG. 4), the overdischarge detecting section 532 determines that overdischarge has occurred, and outputs a close signal to close the switch 58 (to render the switch 58 ON).

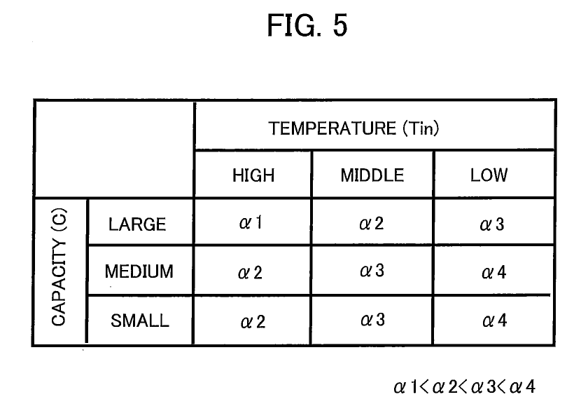

The power supply prohibiting section 533 calculates a voltage drop amount ΔV of each battery cell 510 for each sampling time T2 (described later) based on the voltage of each battery cell 510 detected by the voltage detecting section 530. The power supply prohibiting section 533 determines whether or not to prohibit power supply to the motor 2 based on the calculated voltage drop amount ΔV. More specifically, the power supply prohibiting section 533 stores a table 533a (see FIG. 5) that shows reference voltages (threshold values α) corresponding to the battery temperature T detected by the thermistor 52 and a residual battery capacity C (described later). The power supply prohibiting section 533 determines whether or not to prohibit the power supply by comparing the voltage drop amount ΔV with the reference voltage (threshold value α) corresponding to the battery temperature T and the residual battery capacity C.

If the power supply prohibiting section 533 determines that power should not be supplied to the motor 2, the power supply prohibiting section 533 outputs a close signal to close the switch 58 (to render the switch 58 ON). The determination of the power supply prohibition will be described later in detail. The table 533a may be stored not in the power supply prohibiting section 533 but in a storage unit (not shown), such as a memory. Further, the reference voltages (threshold values α) may correspond to at least one of the battery temperature T and the residual battery capacity C.

When the switch 58 is closed in response to the close signal from the overdischarge detecting section 532 or the power supply prohibiting section 533, the prohibition signal output terminal 56 is connected to the a ground line. Thus, 0V (Lo signal) for prohibiting power supply is outputted to a gate of an FET 410 of the controller 4 (described later) via the prohibition signal output terminal 56.

As shown in FIG. 1, the residual capacity detection unit 59 includes a residual capacity confirmation button 59a and a residual capacity display section 59b. The residual capacity display section 59b displays, by illuminating LEDs, a residual capacity of the battery 51 at the time of user's depression of the residual capacity confirmation button 59a. In the present embodiment, three LEDs are illuminated when the residual battery capacity is large, two LEDs are illuminated when the residual battery capacity is medium, and one LED is illuminated when the residual battery capacity is small. The residual capacity detection unit 59 stores the residual capacity of the battery 51 (the residual battery capacity C) when the residual capacity confirmation button 59a is pressed, and outputs a signal indicative of the residual battery capacity C to the power supply prohibiting section 533 when the power supply prohibiting section 533 performs the power supply prohibition determination. The residual battery capacity C may instead be stored in a storage unit (not shown), such as a memory.

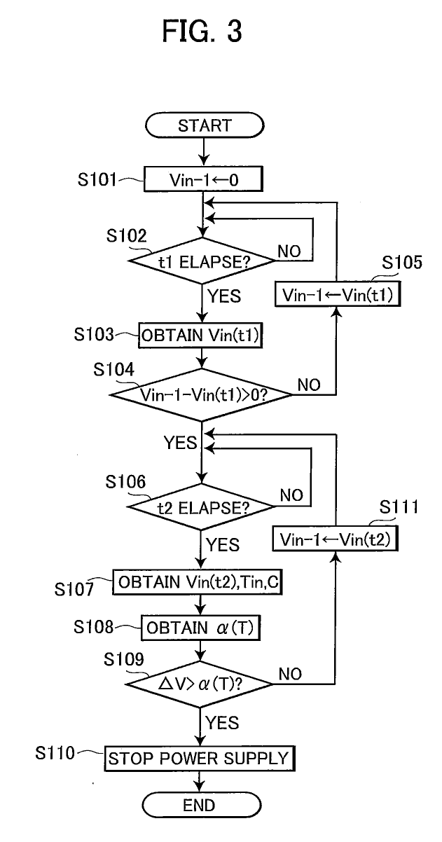

Next, a process to make the power supply prohibition determination according to the first embodiment will be described in detail with reference to FIGS. 3 and 4.

FIG. 3 is a flowchart explaining the power supply prohibition determination. FIG. 4 is a view explaining changes in a voltage and a current in each battery cell 510 when the power supply prohibition determination is performed. A flowchart of FIG. 3 is configured to be launched when the user presses (closes) the trigger switch 31.

When the trigger switch 31 is closed, in S101 the power supply prohibiting section 533 sets a previous battery voltage Vin−1 to 0V as an initial setting. When a predetermined sampling time T1 has elapsed (S102: YES), in S103 the power supply prohibiting section 533 obtains a present battery voltage Vin(t1) of each battery cell 510 from the voltage detecting section 530. As shown in FIG. 4, when the trigger switch 31 is closed, a large starting current instantaneously flows in each battery cell 510, which causes a drastic voltage drop in each battery cell 510 (a region B in FIG. 4). In the present embodiment, the sampling time T1 is set to a value such that the sampling time T1 elapses after the drastic voltage drop has gone down, in order to ignore the drastic voltage drop.

Subsequently, in S104 the power supply prohibiting section 533 determines whether or not the present battery voltage Vin(t1) is smaller than the previous battery voltage Vin−1, i.e., whether or not the present battery voltage Vin(t1) has decreased from the previous battery voltage Vin−1.

When the present battery voltage Vin(t1) is greater than or equal to the previous battery voltage Vin−1, which means that the battery voltage has not decreased (S104: NO), it is presumed that the end bit is not working on a workpiece (i.e., an unloaded (idling) state). Therefore, in S105, the power supply prohibiting section 533 resets the previous battery voltage Vin−1 to the present battery voltage Vin(t1), and returns to S102. Note that since the previous battery voltage Vin−1 is set to 0V in S101, the power supply prohibiting section 533 always makes a NO determination in S104 when executing the S104 for the first time.

When the present battery voltage Vin(t1) is smaller than the previous battery voltage Vin−1, which means that the battery voltage has decreased (S104: YES), it is presumed that the end bit is working on the workpiece (i.e., a loaded state) (a region C in FIG. 4). Therefore, subsequently, the power supply prohibiting section 533 determines whether or not an overload (overcurrent) is occurring.

When a predetermined sampling time T2 has elapsed since it is determined to be “YES” in S104 (S106: YES), in S107 the power supply prohibiting section 533 obtains a present battery voltage Vin(t2) of each battery cell 510 from the voltage detecting section 530, the battery temperature Tin from the thermistor 52, and the residual battery capacity C from the residual capacity detection unit 59. The sampling time T2 is set to a value shorter than the sampling time T1 in order to detect the battery voltage accurately.

In S108, the power supply prohibiting section 533 obtains, from the table 533a, the reference voltage (the threshold value α(T)) corresponding to the obtained battery temperature Tin and the obtained residual battery capacity C. In S109, the power supply prohibiting section 533 determines whether or not a voltage drop amount ΔV during the sampling time T2 (a potential difference between the previous battery voltage Vin−1 and the present battery voltage Vin (t2)) is greater than the threshold value α(T). When the voltage drop amount ΔV is smaller than or equal to the threshold value α(T) (S109: NO), the power supply prohibiting section 533 determines that the end bit is working on the workpiece (the loaded state) but the overload (overcurrent) is not occurring (a region C in FIG. 4). In S111, the power supply prohibiting section 533 resets the previous battery voltage Vin−1 to the present battery voltage Vin(t2), and returns to S106.

On the other hands, when the voltage drop amount ΔV is greater than the threshold value α(T) (S109: YES), it is presumed that the overload (overcurrent) is occurring (a region D in FIG. 4). Therefore, in S110 the power supply prohibiting section 533 outputs the close signal to close the switch 58. In response, 0V (Lo signal) is outputted to the gate of the FET 410 via the prohibition signal output terminal 56. As a result, the FET 410 is turned OFF, stopping the power supply to the motor 2.

As described above, the power tool 1 and the battery pack 5 of the present embodiment can prevent an overcurrent from flowing in each battery cell 510 without detecting the current flowing in each battery cell 510, by detecting the voltage drop amount ΔV for each battery cell 510. Therefore, decrease in the life of each battery cell 510 can be suppressed.

Here, assume that the power tool 1 is embodied as a driver drill for fastening a screw onto a workpiece. Relationships between a battery voltage of each battery cell 510 and a current flowing in each battery cell 510 in this example will be described with reference to FIG. 4 as an explanatory example of the present embodiment.

When the trigger switch 31 is not closed, the battery voltage does not decrease and the current does not flow (a region A in FIG. 4). At the moment that the trigger switch 31 is closed (as soon as the motor 2 is started), a large current flows in the closed circuit (time t0 in FIG. 4), causing the battery voltage to fall drastically. In the present embodiment, since the sampling time T1 is to a value such that the sampling time T1 elapses after the drastic voltage drop has gone down, the motor 2 is prevented from stopping rotating at the starting-up time (a region B in FIG. 4). In this way, in the region B, the processing from S101 to S105 of the flowchart of FIG. 3 are executed.

When the power tool 1 (the driver tool) starts tightening the screw, a load is generated. Due to the load, the current flowing in each battery cell 510 gradually increases and the battery voltage gradually decreases (a region C in FIG. 4), as long as the fastening continues under the constant load. The power supply prohibiting section 533 continues to compare the present (latest) battery voltage with the previous battery voltage (detected last time) (the region C in FIG. 4). In this way, in the region C, the processing from S106 to S109 and S111 of the flowchart of FIG. 3 are executed.

Upon completion of fastening the screw (time to in FIG. 4), the load drastically increases (a region D in FIG. 4). As a result, the current rapidly increases while the battery voltage drastically drops. If the voltage drop amount ΔV during the sampling time T2 is greater than the threshold value α(T) corresponding to the battery temperature Tin and the residual battery capacity C at time tb, the discharge is immediately terminated (time tb in FIG. 4). In this way, in the region D, the processing of S110 of the flowchart of FIG. 3 is executed.

When the trigger switch 31 is opened, the flowchart of FIG. 3 also ends at that time. Further, the voltage detecting section 530 always monitors the battery voltages (voltage of each battery cell 510). If it is detected that the battery voltage of any one of the battery cells 510 becomes smaller than a prescribed overdischarge threshold value Vth, it is presumed that an overdischarge is currently occurring. Therefore, the overdischarge detecting section 532 outputs the close signal to close the switch 58 at any time during the flowchart of FIG. 3, in order to stop the discharge. This configuration contributes to suppression of decrease in the battery life of each battery cell 510 attributed to overdischarge. The determination on the power supply prohibition and overdischarge may be made based on a voltage of the battery 51 as a whole instead of the voltage of each battery cell 510, or based on both of the voltage of each battery cell 510 and the voltage of the battery 51.

FIG. 5 is a view showing an example of the table 533a stored in the power supply prohibiting section 533. In the present embodiment, the decision on the power supply prohibition is made based on the voltage drop amount ΔV between the previous battery voltage Vin−1 and the present battery voltage Vin (t2) in the unloaded (idling) state.

However, normally, under a constant battery temperature, the larger the residual battery capacity C is, the smaller the voltage drop amount ΔV is. Therefore, according to the table 533a of the present embodiment, the threshold value α for “large” amount of the residual battery capacity C is set to a value smaller than those for “medium” and “small” amounts of the residual battery capacity C, as shown in FIG. 5. Further, normally, the lower the temperature is, the greater the internal resistance of the battery cell is, thereby the greater the voltage drop amount ΔV is also. Accordingly, in the table 533a of the present embodiment, threshold value α is set to a value such that the lower the battery temperature Tin is, the larger the threshold value α is.

According to the present embodiment, the threshold value α is selected from among four kinds of threshold values α1 to α4. However, the threshold value α may instead be selected from among an increased number of kinds of threshold values for realizing a more accurate execution of the power supply prohibition. Alternatively, the threshold value α may be set based exclusively on the battery temperature Tin, since the voltage drop amount ΔV tends to be more dependent on the battery temperature Tin rather than the residual battery capacity C.

Next, a detailed configuration of the controller 4 of the power tool 1 according to the first embodiment will be described with reference to FIG. 2. As shown in FIG. 2, the controller 4 includes a main current switch circuit 41, a main current switch-off maintaining circuit 42 and a display section 43.

The main current switch circuit 41 includes the Field Effect Transistor (FET) 410, a resistor 411 and a capacitor 412. The FET 410 has a drain connected to the motor 2, the gate connected to the prohibition signal output terminal 56 and a source connected to the negative terminal 55. The resistor 411 is connected between the positive terminal 54 and the gate of the FET 410. The capacitor 412 is connected between the gate and the source of the FET 410. A junction of the gate of the FET 410, the resistor 411 and the capacitor 412 is called as “junction A.”

When the battery pack 5 is connected to the power tool 1, the battery voltage of the battery 51 is applied to the junction A (the gate of the FET 410) via the resistor 411. Therefore, when a power is normally supplied from the battery pack 5 to the motor 2, the FET 410 is turned ON. On the other hand, when 0V (Lo signal) is inputted to the gate of the FET 410 via the prohibition signal output terminal 56, the FET 410 is turned OFF, shutting off the power supply to the motor 2.

The main current switch-off maintaining circuit 42 serves to keep the FET 410 turned OFF even when the switch 58 is opened (OFF). The main current switch-off maintaining circuit 42 includes an FET 420, resistors 421, 422 and a capacitor 423.

The FET 420 has a drain connected to the gate of the FET 410 and the prohibition signal output terminal 56, and a source connected to the negative terminal 55. A gate of the FET 420 is connected to the drain of the FET 410 via the resistor 421, and also to the negative terminal 55 via the resistor 422 or the capacitor 423 which are connected in parallel. A junction of the gate of the FET 420, the resistor 422 and the capacitor 423 is referred to as “junction B.” A junction connecting the drain of the FET 410 with the gate of the FET 420 via the resistor 421 is referred to as “junction C.” When a voltage is generated at the junction B, the FET 420 is turned ON. When the FET 420 is turned ON, the junction A, which is connected to the drain of the FET 420, is connected to the negative terminal 55 (the grand line). As the result, the gate of the FET 410 connected to the junction A is also connected to the negative terminal 55, thereby the FET 410 is turned OFF.

The display section 43 includes a resistor 430 and a display device 431 (LED in the present embodiment) which are connected in parallel between the drain and the source of the FET 410. While the FET 410 is turned ON, no potential difference is generated between the drain and the source of the FET 410, even if the trigger switch 31 is closed. Therefore, the display section 43 connected between the drain and the source of the FET 410 is not illuminated. On the other hands, when the FET 410 is turned OFF in a state where the trigger 31 is closed, a potential difference is generated between the drain and the source of the FET 410, which causes the current to flow in the display device 431 via the resistor 430 to illuminate the display device 431. With the illumination of the display device 431, the user can recognize that the power tool 1 cannot work due to either overdischarge or overcurrent. Further, the display section 43 may also function as the residual capacity display section 59b (FIG. 1) of the residual capacity detection unit 59. If this is the case, the display section 43 may selectively illuminate and flush the LEDs so as to inform the user of the residual battery capacity C and occurrence of overdischarge or overcurrent.

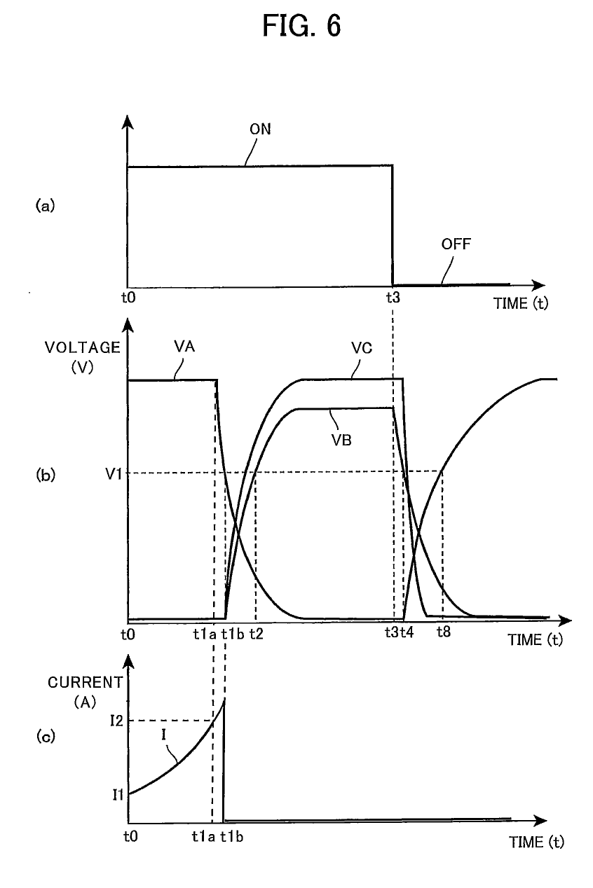

Next, operations of the power tool 1 and the battery pack 5 having the above-described configurations will be described. First, with reference to FIGS. 2 and 6(a) to 6(c), operations of the power tool 1 and the battery pack 5 when the trigger switch 31 is closed in a state where the battery pack 5 is connected to the power tool 1 will be described.

FIG. 6(a) is a time chart showing timings at which a trigger switch 31 is closed and opened. FIG. 6(b) is a time chart showing changes in voltages VA, VB and VC at junctions A, B and C of FIG. 2, respectively, in correspondence with FIG. 6(a). FIG. 6(c) is a time chart showing a current flowing in each battery cell 510 in correspondence with FIG. 6(a).

In FIGS. 6(a), 6(b) and 6(c), time t0 is an arbitrary time when power is normally supplied from the battery pack 5 to the motor 2 in a state in which the trigger switch 31 is closed. As shown in FIG. 6(c), a current I has a value of I1 at the time t0, but the current I then gradually increases to reach an overcurrent value of I2 at a time t1a.

The power supply prohibiting section 533 of the battery pack 5 determines that the power supply should be prohibited when the voltage drop amount ΔV exceeds the threshold value α (at the time t1 in FIG. 6(c)), and outputs the close signal to close the switch 58. When the switch 58 is closed, 0V (Lo signal) is inputted into the gate of the FET 410 via the prohibition signal output terminal 56. As a result, as shown in FIG. 6(b), the voltage VA (voltage at the junction A) starts falling (at the time t1a in FIG. 6(b)). When the voltage VA falls below an on-voltage V1 of the FET 410 (at the time t1b in FIG. 6(b)), the FET 410 is turned OFF. The power supply to the motor 2 is therefore shut down. Note that the on-voltage V1 is common to the FET 410 and the FET 420.

When the FET 410 is turned OFF, the voltage VC (voltage at the junction C) starts increasing. At the same time, a voltage VB (voltage at the junction B) also starts increasing. When the voltage VB exceeds the on-voltage of V1 of the FET 420 (t2 in FIG. 6(b)), the FET 420 is turned ON. As a result, the junction A, i.e., the gate of the FET 410, is connected to the negative terminal 55.

Suppose here that the power tool 1 is not provided with the main current switch-off maintaining circuit 42. When a predetermined period has elapsed since the FET 410 is turned OFF, the overcurrent state is resolved. When the overcurrent state is resolved, the FET 410 is turned ON to resume the power supply. However, as soon as the power supply starts again, another overcurrent state will result, leading to the FET 410 being again turned OFF.

In contrast, in the power tool 1 according to the present embodiment provided with the main current switch-off maintaining circuit 42, the FET 420 is turned ON when the FET 410 is turned OFF. Since the drain of the FET 420 is connected to the gate of the FET 410, 0V is continuously applied to the gate of the FET 410 as long as the trigger switch 31 is closed even if the switch 58 is opened. Therefore, the FET 410 can maintain to be turned OFF even after the overcurrent has resolved. As the result, the power supply to the motor 2 continues to be shut down.

When the trigger switch 31 is opened (time t3 in FIGS. 6(a) and 6(b)), the voltage VB starts decreasing. The voltage VC also starts decreasing due to the time constant of the capacitors and the resistors slightly after the voltage VB starts decreasing. Note that the difference between the timing when the voltage VB starts decreasing and the timing when the voltage VC starts decreasing is extremely small. Therefore, these timings can be regarded as substantially identical.

When the voltage VB decreases below the on-voltage V1 (time t4 in FIG. 6(b)), the FET 420 is turned OFF. Once the FET 420 is turned OFF, the battery voltage is applied to the gate of the FET 410 via the resistor 411, which causes an increase in the voltage VA. When the voltage VA exceeds the on-voltage V1 (time t8 in FIG. 6(b)), the FET 410 is turned ON. When the trigger switch 31 is closed at this state, the power supply to the motor 2 is achieved. In case of overdischarge, the same operations as those in the overcurrent are performed.

As described above, according to the power tool 1 of the present embodiment, when the power supply to the motor 2 is shut off by the FET 410 in the state that the trigger switch 31 is closed, the main current switch-off maintaining circuit 42 maintains the state where the power supply to the motor 2 is prohibited as long as the trigger switch 31 is closed. This configuration can prevent permission and prohibition of the power supply from being alternately repeated in a short period of time. In case of overdischarge, the main current switch-off maintaining circuit 42 also functions in the same manner as in the case of overcurrent.

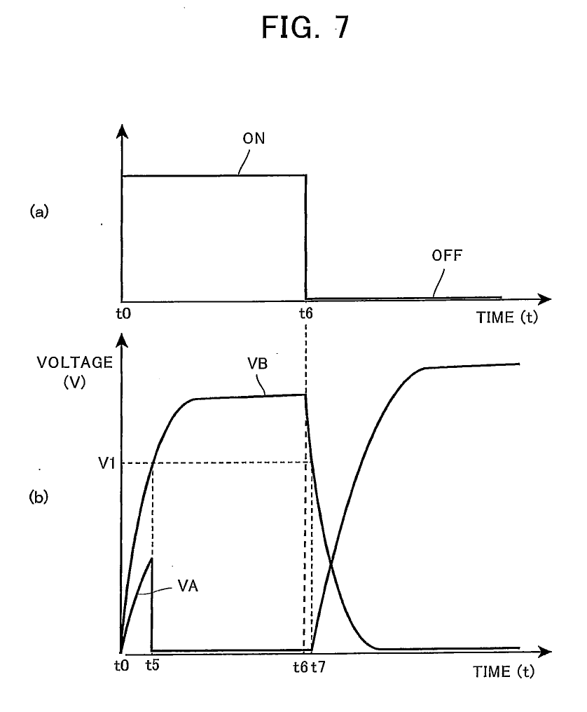

Next, with reference to FIGS. 2, 7(a) and 7(b), operations of the power tool 1 and the battery pack 5 when the battery pack 5 is connected to the power tool 1 in a state where the trigger switch 31 is closed will described.

FIG. 7(a) is a time chart showing timings at which the trigger switch 31 is closed and opened. FIG. 7(b) is a time chart showing changes in the voltages VA and VB at the junctions A and B of FIG. 2, respectively, in correspondence with FIG. 7(a).

In FIGS. 7(a) and 7(b), time t0 is a time at which the battery pack 5 is connected to the power tool 1 in a state where the trigger switch 31 is closed. When the battery pack 5 is connected to the power tool 1 at the time t0, the voltages VA starts increasing, as shown in FIG. 7(b). Further, the voltage VB also starts increasing, as shown in FIG. 7(b), since the FET 410 is turned OFF.

In the present embodiment, the time constant for a circuit configured of the resistor 411 and the capacitor 412 and the time constant for a circuit configured of the resistor 421 and the capacitor 423 are set to values such that the voltage VB increases faster than the voltage VA. More specifically, in the present embodiment, the resistor 411, the capacitor 412, the resistor 421 and the capacitor 423 are set to 1 MΩ, 1 μF, 1 kΩ and 1 μF respectively. When the voltage VB exceeds the on-voltage V1 (time t5 in FIG. 7(b)), the FET 420 is turned ON, which causes the voltage VA to become 0V. Thus, 0V (Lo signal) is inputted to the gate of the FET 410 to preventing the FET 410 from being turned ON. The OFF state of the FET 410 is maintained until the trigger switch 31 is opened.

When the trigger switch 31 is opened (time t6 in FIG. 7(a)), the electrical charge of the capacitor 423 is discharged via the resistor 422. Therefore, the battery voltage does not become applied to the junction B (the gate of the FET 420), causing the voltage VB to decrease. When the voltage VB decreases below the on-voltage V1 (time t7 in FIG. 7(b)), the FET 420 is turned OFF. When the FET 420 is turned OFF, the voltage VA starts increasing.

With this configuration, even if the battery pack 5 is connected to the power tool 1 in a state where the trigger switch 31 is closed, the power supply to the motor 2 is prevented. Therefore, it is prevented that the power tool 1 starts operating as soon as the battery pack 5 is connected to the power tool 1.

According to the power tool 1 and the battery pack 5 of the present embodiment, whether or not to prohibit the power supply is determined based on the voltage drop amount of each battery cell 510. Hence, an overcurrent can be prevented from flowing in the battery 51 without detecting a current, thereby suppressing a decrease in a life of the battery 51.

Further, the threshold value α is determined depending on the battery temperature T and the residual battery capacity C of the battery 51. Therefore, an overcurrent can be prevented from flowing in the battery 51 more appropriately.

Further, even if the power supply to the motor 2 is shut off by the FET 410 in a state the trigger switch 31 is closed, the prohibition of the power supply to the motor 2 can be maintained by the main current switch-off maintaining circuit 42. Therefore, permission and prohibition of the power supply can be prevented from being repeated in a short period of time.

Further, since the lithium-ion battery is used as the battery cell 510, more effective prevention of overcurrent can be realized.

Further, since the motor 2 (discharge) is stopped immediately upon detection of overcurrent, a decrease in the battery life of the secondary battery can be suppressed. Moreover, in the present embodiment, the drastic voltage drop at the time of start-up of the motor 2 (i.e., when the trigger switch 31 is closed) is not determined to be the overcurrent. Therefore, the motor 2 is prevented from stopping immediately after the power tool 1 starts operating, leading to enhancement of workability.

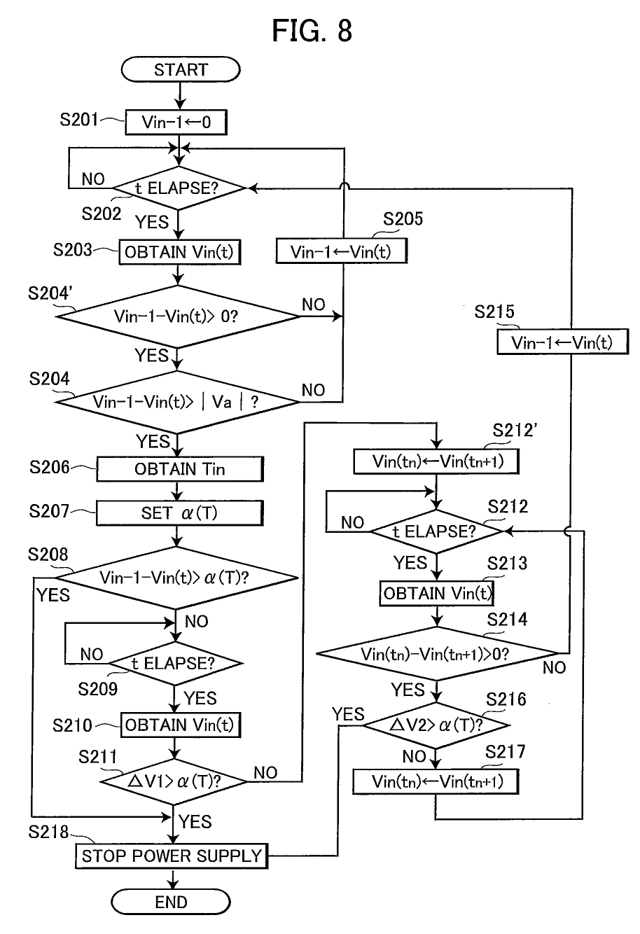

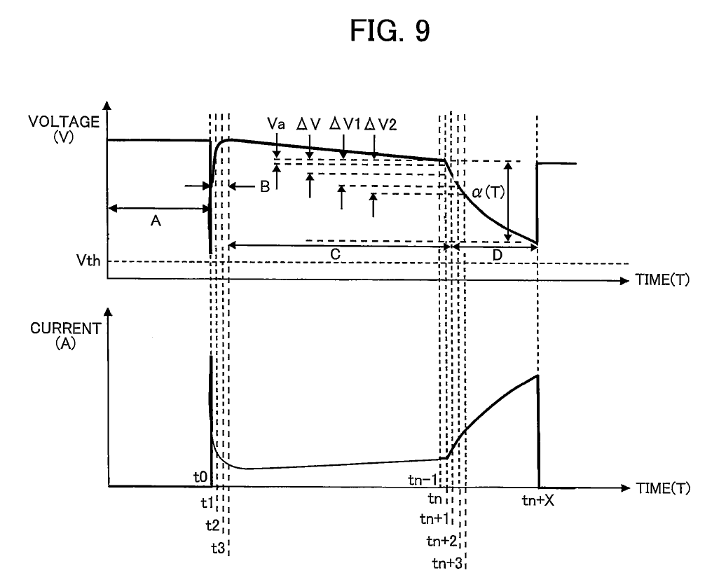

Next, a process to make the power supply prohibition determination according to a second embodiment of the present invention will be described with reference to FIGS. 8 and 9. In the following description, like parts and components are designated by the same reference numerals as those of the first embodiment in order to avoid duplicating description.

In the first embodiment, when the present battery voltage Vin(t1) is smaller than the previous battery voltage Vin−1 (S104 of FIG. 3: YES), the power supply prohibiting section 533 determines that the loaded state is occurring. However, minute noises may often cause the battery voltage to decrease. In such case, the power supply prohibiting section 533 of the first embodiment may also determine that the loaded state is occurring. Therefore, in the second embodiment, when a potential difference between the previous battery voltage Vin and the present battery voltage Vin−1 is greater than a threshold value Va, the power supply prohibiting section 533 determines that the loaded state is occurring.

Further, in the first embodiment, when a voltage drop amount ΔV during the sampling time T2 (a potential difference between the previous battery voltage Vin−1 and the present battery voltage Vin (t2)) is greater than the threshold value α(T) (S109 of FIG. 3: YES), the power supply prohibiting section 533 determines that the overload (overcurrent) is occurring. However, the voltage drop amount ΔV can gradually increase in accordance with a gradual increase in the load. In such case, the power supply prohibiting section 533 of the first embodiment does not determine that the overload (overcurrent) is occurring, even if the overload (overcurrent) is occurring. Therefore, in the second embodiment, when the voltage continues to drop, the power supply prohibiting section 533 determines that the loaded state is occurring.

FIG. 8 is a flowchart explaining the power supply prohibition determination according to the second embodiment. FIG. 9 is a view explaining changes in a voltage and a current in each battery cell 510 when the power supply prohibition determination according to the second embodiment is performed.

In the first embodiment, a time different from the sampling time T1 is used as the sampling time T2 (t1>t2). However, in the second embodiment, a single sampling time T is used. More specifically, the sampling time T is set to a value such that the sampling time T elapses after the battery voltage that has decreased due to the drastic voltage drop at the time of start-up of the motor 2 (i.e., when the trigger switch 31 is closed) recovers above the threshold value α.

In the flowchart of FIG. 8, the processing from S201 to S203 are identical to the processing from S101 to S103 of the flowchart of FIG. 3.

In S204′ the power supply prohibiting section 533 determines whether or not the present battery voltage Vin(t) is smaller than the previous battery voltage Vin−1, i.e., whether or not the present battery voltage Vin(t) has decreased from the previous battery voltage Vin−1. When the present battery voltage Vin(t) is greater than or equal to the previous battery voltage Vin−1, which means that the present battery voltage Vin(t) has not decreased from the previous battery voltage Vin−1 (S204′: NO), in S205 the power supply prohibiting section 533 resets the previous battery voltage Vin−1 to the present battery voltage Vin(t), and returns to S201. Since the previous battery voltage Vin−1 is set to 0V in S201 (at time t0 in FIG. 9), the power supply prohibiting section 533 always makes a NO determination in S204′ (at time t1 in FIG. 9) when executing the S204′ for the first time. Therefore, when executing the S204′ for the first time, in S205 the power supply prohibiting section 533 resets the previous battery voltage Vin−1 to the present battery voltage Vin(t1) detected at time t1 when the sampling time T has elapsed after time to.

When executing the S204′ for the second time, the present battery voltage Vin(t2) detected at time t2 when the sampling time T has elapsed after the time t1, becomes greater than the battery voltage Vin(t1) detected at the time t1 (i.e., the previous battery voltage Vin−1), as shown in a region B in FIG. 9. Since the present battery voltage Vin(t2) is not smaller than the previous battery voltage Vin−1 (S204′: NO), the power supply prohibiting section 533 again resets the previous battery voltage Vin−1 to the present battery voltage Vin(t2) detected at the time t2 in S205.

In this way, in the second embodiment, the power supply prohibiting section 533 does not makes an YES determination in S204′ (a region B in FIG. 9) until the battery voltage that has decreased due to the drastic voltage drop at the time of start-up of the motor 2 fully recovers.

On the other hand, when the present battery voltage Vin(t) becomes smaller than the previous battery voltage Vin−1 (at time t3 in FIG. 9) (S204′: YES), it is presumed that the loaded state is occurring. Therefore, the power supply prohibiting section 533 determines whether or not an overload (overcurrent) is occurring in the following steps.

However, minute noises may often cause the battery voltage to decrease. Therefore, in the second embodiment, in S204, the power supply prohibiting section 533 determines whether or not a potential difference between the previous battery voltage Vin and the present battery voltage Vin−1 is greater than a threshold value Va (an absolute value). The threshold Va is set to a value that can ignore the variation in the battery voltage due to the minor noises. Therefore, even if the battery voltage is varied due to minor noises, the power supply prohibiting section 533 does not make an YES determination in S204.

Further, the battery voltage may decrease in a slow pace in the loaded state. In such case, the potential difference between the previous battery voltage Vin−1 and the present battery voltage Vin(t) may not exceed the threshold value Va. Therefore, the steps 204 and 205 are repeated until the time tn in FIG. 9.

On the other hand, when the potential difference between the battery voltage Vin−1 (at the time tn in FIG. 9) and the battery voltage Vin(t) (at the time tn+1 in FIG. 9) is greater than the threshold Va (S204: YES), it is presumed that a great load is applied. Therefore, the power supply prohibiting section 533 performs a process to determine whether or not an overloaded (overcurrent) state has occurred. This determination is made during a region D in FIG. 9. In the example of FIG. 9, at a time tn+1, a voltage drop amount ΔV (the potential difference) between the battery voltage Vin-1 and the battery voltage Vin(t) becomes greater than the threshold Va. Therefore, at the time tn+1, the determination of YES in S204 is done.

In S206 the power supply prohibiting section 533 obtains the battery temperature Tin from the thermistor 52, and in S207 obtains the threshold value α(T) corresponding to the obtained battery temperature Tin. In S208 the power supply prohibiting section 533 determines whether or not the voltage drop amount ΔV between the battery voltages Vin−1 and Vin(t) is greater than the threshold value α(T). When the voltage drop amount ΔV between the battery voltages Vin−1 and Vin(t) is greater than the threshold value α(T) (S208: YES), it is presumed that a drastic voltage drop is happening. Therefore, the power supply prohibiting section 533 determines that the overloaded (overcurrent) state has occurred, outputs a signal to close the switch 58 in S218 and terminates the discharge from the battery cells 510.

On the other hand, when the voltage drop amount ΔV between the battery voltage Vin−1 and Vin(t) is smaller than or equal to the threshold value α(T) (S208: NO), after the sampling time T has passed next (S209: YES), in S210 the power supply prohibiting section 533 obtains the latest battery voltage Vin(t) of each battery cell 510 (i.e., a battery voltage Vtn+2 at a time tn+2 in FIG. 9) from the voltage detecting section 530, and in S211, determines whether or not a voltage drop amount ΔV1 between the latest battery voltage Vin(t) (i.e., the battery voltage Vtn+2) and the battery voltage Vin−1 (i.e., the battery voltage Vtn at the time tn) is larger than the threshold value α(T).

When the voltage drop amount ΔV1 is greater than the threshold value α(T) (S211: YES) although the voltage drop amount ΔV between the battery voltage Vin-1 and the battery voltage Vin(t) did not exceed the threshold value α(T) (S208: NO), the power supply prohibiting section 533 determines that the overloaded state has occurred and outputs a signal to close the switch 58 in 5218 in order to terminate the discharge.

On the other hand, when the voltage drop amount ΔV1 is smaller than or equal to the threshold value α(T) (S211: NO), the overloaded state has not yet occurred, but there is still a possibility that the battery voltage may gradually decrease (the current may increase) to cause overcurrent. In S212′ the power supply prohibiting section 533 stores the battery voltage Vin(tn+1) (i.e., the battery voltage Vtn+2 at the time tn+2) as the battery voltage Vin(t1). Subsequently, after another sampling time T has passed (S212: YES), the power supply prohibiting section 533 obtains the latest battery voltage Vin(t) (i.e., a battery voltage Vtn+3 at a time tn+3) from the voltage detecting section 530 in 5213. In 5214 the power supply prohibiting section 533 determines whether or not the obtained battery voltage Vin(t) is smaller than the battery voltage Vin(t) detected last time (i.e., the battery voltage Vtn+2 at the time tn+2), that is, whether or not the latest battery voltage Vin(t) (the battery voltage Vtn+3) has decreased from the previous battery voltage Vin(t) (the battery voltage Vtn+2).

When the latest battery voltage Vin(t) (the battery voltage Vtn+3) is greater than or equal to the previous battery voltage Vin(t) (the battery voltage Vtn+2) (S214: NO), which means that the voltage drop is no more occurring, the power supply prohibiting section 533 updates the value of the battery voltage Vin−1 with that of the latest battery voltage Vin(t) (the battery voltage Vtn+3) in S215 and returns to S202. However, there is still a possibility that the battery voltage has stopped dropping only temporarily and may start dropping again. Therefore, as an alternative, the power supply prohibiting section 533 may, after NO determination in S204, compare the battery voltage at the next sampling with the previous battery voltage, and may continue to detect occurrence of overcurrent if there is a voltage drop.

When the battery voltage Vin(t) (the battery voltage Vtn+3) is smaller than the battery voltage Vin(t) (the battery voltage Vn+2) (S214: YES), which means that the battery voltage continues to be falling, the power supply prohibiting section 533 then determines in S216 whether or not a potential difference ΔV2 between the battery voltage Vtn at the time tn when the battery voltage starts falling (the battery voltage Vin−1 stored in S205) and the latest battery voltage Vin(t) at the time tn+3 (the battery voltage Vtn+3) is greater than the threshold value α(T).

When the potential difference ΔV2 is greater than the threshold value α(T) (S216: YES), the power supply prohibiting section 533 determines that the overloaded state is occurring, and outputs a signal to close the switch 58 in S218 in order to terminate the overdischarge. On the other hand, when the potential difference ΔV2 is equal to or smaller than the threshold value α(T) (S216: NO), in S217 the power supply prohibiting section 533 updates the value of the previous battery voltage Vin(t) with the value of the latest battery voltage Vin(t), that is, the battery voltage Vn+2 detected last time at the time tn+2 is replaced with the latest battery voltage Vtn+3 at the time tn+3, and returns to S212. As long as the battery voltage keeps falling down (as long as YES is determined in S214), the processing from S212 to S217 are repeated until a time tn+x in FIG. 9.

A the time tn+x, the potential difference ΔV2 between the battery voltage Vtn at the time tn when the voltage drop occurred (corresponding to Vin−1) and the battery voltage Vtn+x at the time tn+x becomes greater than the threshold value α(T). The power supply prohibiting section 533 therefore determines YES in 5216 and terminates discharge.

In the second embodiment, the threshold value α(T) is set in S207 based on only the battery temperature T. However, as the first embodiment, the threshold value α(T) may be set in accordance with both of the battery temperature T and the residual battery capacity C. Further, since the battery temperature T and the residual battery capacity C change during the discharge, the threshold value α(T) may be set appropriately during the processing from S212 to S217 based on the battery temperature T and the residual battery capacity C. This configuration enables overcurrent to be detected with more accuracy, further leading to more reliable suppression of decrease in the secondary batteries.

According to the above-described configuration of the second embodiment, determination on power supply prohibition can be made regardless of the effects of small voltage drops caused by minute noises or load. Further even in case that the amount of voltage drop (current) gradually increases in accordance with gradual increase in the load, the power supply prohibition determination can be reliably made.

The power tool 1 and the battery pack 5 according to the present invention is not limited to the embodiments described above. It will be appreciated by one skilled in the art that a variety of changes and modifications may be made without departing from the scope of the invention.

For example, in the above-described embodiments, the power supply prohibiting section 533 and the switch 58 are provided in the battery pack 5, while the FET 410 is provided in the power tool 1. However, the power supply prohibiting section 533, the switch 58 and the FET 410 may be provided in any combination within the battery pack 5 and the power tool 1. Further, as long as the power supply to the motor 2 can be shut down in response to the output signals from the power supply prohibiting section 533, the switch 58 and the FET 410 may have configurations different from those in the first and second embodiments.

Further, in the foregoing embodiments, the power supply prohibition determination is made based on the voltage drop amount of each battery cell 510 without detecting current flowing through the battery cells 510 (the motor 2). However, the current may also be detected. In the latter case, whether or not to prohibit the power supply is determined based on the voltage drop amount of the battery cells 510, and whether or not overcurrent has occurred is determined based in the detected current. With this configuration, overcurrent can be prevented more reliably.

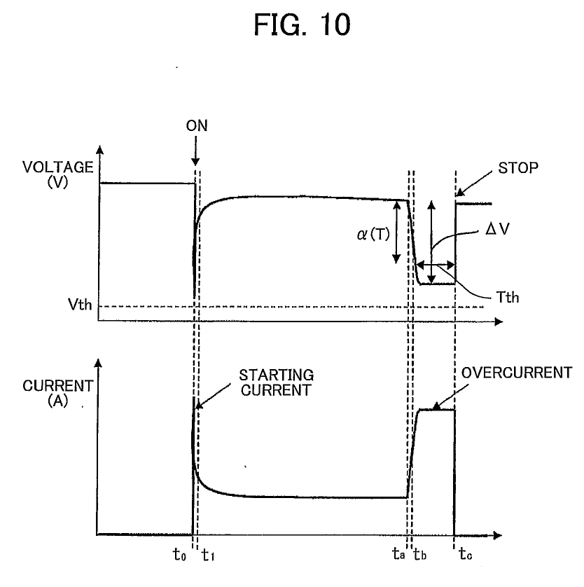

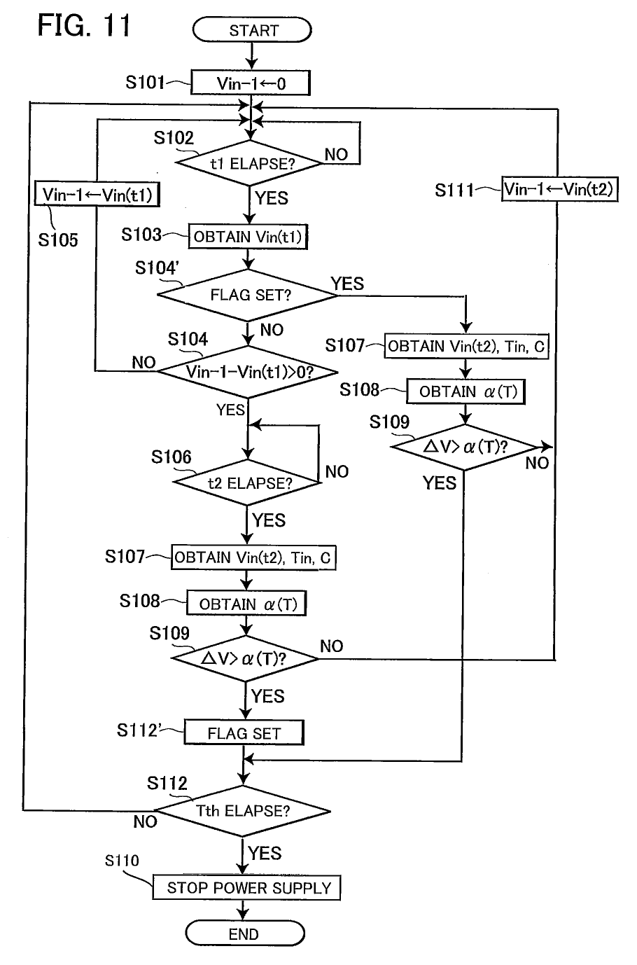

Further, in the above embodiments, overcurrent is determined to have occurred immediately when the voltage drop amount ΔV exceeds the threshold value α, and the FET 410 is shut down accordingly. However, as shown in FIGS. 10 and 11, the FET 410 may be shut off when the voltage drop amount ΔV continues to exceed the threshold value α for more than a prescribed period of time Tth. Referring to FIG. 10, a sampling time T is set constant, and the voltage drop amount ΔV has exceeded the threshold value α for the prescribed period of time Tth. The discharge is then terminated (the FET 410 is shut off) at a time tc. A flowchart of FIG. 11 is identical to the flowchart of FIG. 3 except in that the sampling time T is constant; the power supply prohibiting section 533 determines whether or not the prescribed period of time Tth has passed after the YES determination in S109; and the power supply prohibiting section 533 checks whether or not a flag is set.

More specifically, with reference to FIG. 11, after determining YES in S109, the power supply prohibiting section 533 sets a flag in S112′ and determines whether or not the overcurrent state has continued for more than the prescribed period of time Tth in S112. When overcurrent lasts for more than the prescribe period of time Tth (S112: YES), discharge is terminated. On the other hand, when overcurrent continues for less than the prescribed period of time Tth (S112: NO), the power supply prohibiting section 533 returns to S102 and determines in S104′ whether or not the flag has been set. When the flag has been set (S104′: YES), the power supply prohibiting section 533 repeats the determination in S109.

Given that the period of the initial drastic voltage drop (overcurrent) at the time of turning on the trigger switch 31 is so short (minimal), the prescribed period of time Tth may be set to be longer than the period of the initial voltage drop (for example, twice as long as the period during which the initial drastic voltage drop exceeding the threshold value α continues). In this case, assuming that the sampling time T is minimal, the power supply prohibiting section 533 may determine YES in S104 at the time when the trigger switch 31 is turned ON and also determine YES in S109. However, the drastic voltage drop that occurs upon starting up the motor 2 lasts only for a short period of time, i.e., less than the prescribed period of time Tth. Therefore, the power supply prohibiting section 533 determines NO in S112, and the discharge is never stopped at the time when the motor 2 is started. The period of time Tth may alternatively be set appropriately based on the battery temperature T and the residual battery capacity C.

Further, in the first embodiment, the sampling time T1 at the time of starting-up of the motor 2 and the sampling time T2 that is used once the motor 2 has started are set differently from each other. However, this differentiation of the sampling time may also be employed in the second embodiment. Alternatively, a constant sampling time may be employed in the first embodiment. In other words, the sampling time may be set such that the initial voltage drop can be ignored (tolerated); the FET 410 is never shut off at the time of starting the motor 2; and drops in battery voltages can be detected with certainty.

Further in the above embodiments, the residual capacity detection unit 59 detects and stores the residual battery capacity C of the battery 51 when the user presses the residual capacity confirmation button 59a. However, instead, the residual capacity detection unit 59 may detect and store the residual battery capacity C of the battery 51 when the trigger switch 31 is turned off, or when the battery pack 5 is detached from the power tool 1. Alternatively, the residual capacity detection unit 59 may detect and store the residual battery capacity C of each battery cell 510. Still alternatively, the threshold value α may be set based on the residual battery capacity C and the battery temperature T only when the residual capacity confirmation button 59a is pressed. Unless the residual capacity confirmation button 59a is pressed, the threshold value α may be set based solely on the battery temperature T, or may be set as a fixed value irrespective of the battery temperature T and the residual battery capacity C. When the battery temperature T only is used for determining the threshold value α, the threshold value α should be set so as to be greater as the battery temperature T is lower.

Further, although the power supply prohibiting section 533 obtains the threshold value α(T) in accordance with the battery temperature Tin and the residual battery capacity C in the above embodiments, either one of the battery temperature Tin and the residual battery capacity C may be considered upon obtaining the threshold value α(T).

Further, the lithium-ion battery is used for the battery cell 510 in the above embodiments, but the battery cell 510 is not limited to the lithium-ion battery.

1. A power tool connectable to a battery pack including a secondary battery, comprising:
a motor driven with an electrical power supplied from the secondary battery; and
a prohibiting unit that prohibits the supply of the electrical power to the motor based on a drop amount of a voltage of the secondary battery.

2. The power tool according to claim 1, wherein the prohibiting unit prohibits the supply of the electrical power to the motor when the drop amount exceeds a first threshold.

3. The power tool according to claim 1, wherein the first threshold depends on at least one of a temperature of the secondary battery and a capacity of the secondary battery.

4. The power tool according to claim 1, further comprising a trigger switch that is manually closed to supply the electrical power to the motor,
wherein once prohibiting the supply of the electrical power to the motor, the prohibiting unit continues to prohibit the supply of the electrical power to the motor until the trigger switch is opened.

5. The power tool according to claim 1, further comprising a trigger switch that is manually closed to supply the electrical power to the motor,
wherein the prohibiting unit detects the drop amount every predetermined period since the trigger switch has been closed, the predetermined period being set to a value such that the prohibiting unit fails to detect the drop amount occurring due to a starting current.

6. The power tool according to claim 1, wherein the prohibiting unit prohibits the supply of the electrical power to the motor by shutting off a switching unit disposed on a current path between the secondary battery and the motor.

7. The power tool according to claim 1, wherein the secondary battery is a lithium-ion secondary battery.

8. The power tool according to claim 2, wherein the prohibiting unit prohibits the supply of the electrical power to the motor, at least one of when the drop amount exceeds the first threshold and when a capacity of the secondary battery falls below a second threshold for an overdischarge.

9. A battery pack connectable to a power tool including a motor, comprising:
a secondary battery that supplies an electrical power to the motor to drive the motor; and
a prohibiting unit that prohibits the supply of the electrical power to the motor based on a drop amount of a voltage of the secondary battery.

10. The battery pack according to claim 9, wherein the prohibiting unit prohibits the supply of the electrical power to the motor when the drop amount exceeds a first threshold.

11. The battery pack according to claim 9, wherein the first threshold depends on at least one of a temperature of the secondary battery and a capacity of the secondary battery.

12. The battery pack according to claim 9, further comprising a trigger switch that is manually closed to supply the electrical power to the motor,
wherein once prohibiting the supply of the electrical power to the motor, the prohibiting unit continues to prohibit the supply of the electrical power to the motor until the trigger switch is opened.

13. The battery pack according to claim 9, further comprising a trigger switch that is manually closed to supply the electrical power to the motor,
wherein the prohibiting unit detects the drop amount every predetermined period since the trigger switch has been closed, the predetermined period being set to a value such that the prohibiting unit fails to detect the drop amount occurring due to a starting current.

14. The battery pack according to claim 9, wherein the prohibiting unit prohibits the supply of the electrical power to the motor by shutting off a switching unit disposed on a current path between the secondary battery and the motor.

15. The battery pack according to claim 9, wherein the secondary battery is a lithium-ion secondary battery.

16. The battery pack according to claim 10, wherein the prohibiting unit prohibits the supply of the electrical power to the motor, at least one of when the drop amount exceeds the first threshold and when a capacity of the secondary battery falls below a second threshold for an overdischarge.
